(19) United States
(12) Patent Application Publication
(10) Pub. No.: US 2021/0296660 A1
(43) Pub. Date: Sep. 23, 2021

(54) BIPOLAR PLATE OF FUEL CELL AND METHOD FOR MANUFACTURING THE SAME

(71) Applicant: TSINGHUA UNIVERSITY, Beijing (CN)

(72) Inventors: ZUN-YAN HU, Beijing (CN); JIAN-QIU LI, Beijing (CN); LIANG-FEI XU, Beijing (CN); HUI-ZE LIU, Beijing (CN); LING XU, Beijing (CN); MING-GAO OUYANG, Beijing (CN)

(21) Appl. No.: 17/341,262

(22) Filed: Jun. 7, 2021

Related U.S. Application Data
(63) Continuation of application No. PCT/CN2020/073198, filed on Jan. 20, 2020.

(30) Foreign Application Priority Data
Oct. 22, 2019 (CN) 201911005875.X
Oct. 22, 2019 (CN) 201911006521.7
Oct. 22, 2019 (CN) 201911006524.0

(51) Int. Cl. H01M 8/0265; H01M 8/026; H01M 8/0263; H01M 8/0228

(52) U.S. Cl. CPC H01M 8/0265; H01M 8/0228; H01M 8/0263; H01M 8/026

(57) ABSTRACT

The present disclosure relates to a fuel cell bipolar plate including a substrate. A surface of the substrate defines a first flow channel and a second flow channel adjacent to the first flow channel. A rib is formed between the first flow channel and the second flow channel. A top surface of the rib defines a groove or a second bore. One or both of the first flow channel and the second flow channel is in fluid communication with the groove or the second bore.

### CROSS-REFERENCE TO RELATED APPLICATIONS

This application claims priorities of China Patent Application No. 201911005875.X, filed on Oct. 22, 2019, entitled “METHOD FOR MANUFACTURING BIPOLAR PLATE OF FUEL CELL”, China Patent Application No. 201911006524.0, filed on Oct. 22, 2019, entitled “BIPOLAR PLATE OF FUEL CELL AND METHOD FOR MANUFACTURING THE SAME”, and China Patent Application No. 201911006521.7, filed on Oct. 22, 2019, entitled “BIPOLAR PLATE OF FUEL CELL”, the contents of which are hereby incorporated by reference in their entirety. This application is a continuation under 35 U.S.C. §120 of international patent application PCT/CN2020/073198, filed on Jan. 20, 2020, the content of which is also hereby incorporated by reference in its entirety.

### TECHNICAL FIELD

The present disclosure relates to the field of fuel cells, and particularly relates to bipolar plates of fuel cells and methods for manufacturing the same.

### BACKGROUND

Bipolar plates are the core components of fuel cells. The bipolar plate design is one of the main factors that determine the fuel cell performance. Structures such as cathode flow channels, anode flow channels, cooling flow channels, etc. are defined on the surfaces of bipolar plates. The cathode and anode flow channels undertake functions, such as reactant gas distribution, gas cooling, and water drainage, in the fuel cells.

In the art known to the inventors, the flow channels or grooves of the bipolar plates are usually formed by machining or compression molding. Reducing the width of a flow channel rib can increase the efficiency of diffusing the reactant gas to the area behind the rib. Therefore, increasing the distribution density of the flow channels can improve the performance of the fuel cells. Due to the brittleness of graphite materials and the affects of the molds, it is difficult to form densely distributed flow channels with relatively narrow ribs by machining or compression molding. As a result, the widths of the flow channel ribs of a conventional bipolar plate product are about 1 mm. In the art known to the inventors, it will greatly increase cost and time to further reduce the widths of the flow channel ribs. Whereas, there is a need to reduce the widths of the flow channel ribs to a range from 2 mm to 0.3 mm to further make a breakthrough in improving the performance of the fuel cells.

The flow channels of the bipolar plates are responsible for multiple tasks such as evenly distributing the gaseous reactants and discharging the generated water. When the fuel cells are in operation, driven by the reactant gas flows, the water generated by the reactions will move to the outlet ends of the flow channels. The amounts of the liquid state water in the flow channels and the gas diffusion layer gradually increase along the direction from the inlet ends to the outlet ends of the flow channels. The liquid state water hinders the transport of the reactant gases. The key to improving the performance of the fuel cells is promoting the transport performance of the gases and improving the drainage capacity of the flow channels.

### SUMMARY

In view of this, there is a need to provide a manufacturing method of the bipolar plate to improve the performance of the fuel cell.

A manufacturing method for the fuel cell bipolar plate is disclosed. The method includes:
providing a graphite bipolar plate blank;
drawing an overall processing path pattern according to a layout of target flow channels;
forming flow channels on a surface of the graphite bipolar plate blank by using a laser according to the overall processing path pattern to obtain a shaped graphite bipolar plate; and
cleaning and hydrophobic treating the surface of the shaped graphite bipolar plate.

In the present disclosure, the manufacturing method for the bipolar plate of the fuel cell forms flow channels on a surface of the graphite bipolar plate blank by using a laser. According to a layout of target flow channels, this method can obtain a shaped graphite bipolar plate. In the art known to the inventors, widths of the flow channel ribs processed by machining are in millimeter-scales, and widths of those processed by the compression molding are also in millimeter-scales. The present manufacturing method adopts a laser to form the flow channels. The laser forms a light spot with a microscale diameter and does not generate mechanical stress. The laser can be used to form more densely distributed flow channels with narrower rib widths. Further, the manufacturing method includes a surface cleaning treatment and a surface hydrophobic treatment applied on the shaped graphite bipolar plate. After the surface hydrophobic treatment, the flow channels are not easy to accumulate water. Furthermore, the transporting ability of the flow channels of the bipolar plate formed by the manufacturing method is enhanced, and the manufacturing method improves the performance of the bipolar plate.

### BRIEF DESCRIPTION OF THE DRAWINGS

FIG. 1 is a flow chart of a manufacturing method for a fuel cell bipolar plate provided in an embodiment of the present disclosure.

FIG. 2 is a structural view of a layout of target flow channels provided in an embodiment of the present disclosure.

FIG. 3 is a structural view of an overall processing path pattern provided in an embodiment of the present disclosure.

FIG. 4 is a partial structural view of the region A-A of FIG. 3.

FIG. 5 is a schematic structural view of a laser etching machine provided in an embodiment of the present disclosure.

FIG. 6 is a schematic view showing positions of refractors provided in an embodiment of the present disclosure.

FIG. 7 is a photograph of flow channels of a shaped graphite bipolar plate provided in an embodiment of the present disclosure.

FIG. 8 is a schematic structural view of the fuel cell bipolar plate provided in an embodiment of the present disclosure.

FIG. 9 is a structural top view of the fuel cell bipolar plate provided in an embodiment of the present disclosure.

FIG. 10 is a cross-sectional view taken along the line A-A of FIG. 9 in an upside-down direction.

FIG. 11 is a structural top view showing ribs defining oblique grooves provided in an embodiment of the present disclosure.

FIG. 12 is a structural top view showing bores on bottom surfaces of grooves provided in an embodiment of the present disclosure.

FIG. 13 is a cross-sectional view taken along the line B-B of FIG. 12 in an upside-down direction.

FIG. 14 is a structural top view showing bores on bottom surfaces of oblique grooves provided in an embodiment of the present disclosure.

FIG. 15 is a structural top view showing bores on ribs provided in an embodiment of the present disclosure.

FIG. 16 is a cross-sectional view taken along the line C-C of FIG. 15 in an upside-down direction.

FIG. 17 is a structural view of the fuel cell bipolar plate provided in an embodiment of the present disclosure.

FIG. 18 is a structural top view of flow channels with linearly, continuously changing widths provided in an embodiment of the present disclosure.

FIG. 19 is a structural side view of the fuel cell bipolar plate provided in an embodiment of the present disclosure.

FIG. 20 is a cross-sectional view taken along the line A-A of FIG. 19.

FIG. 21 is a cross-sectional view of flow channels in shape of hexagon provided in an embodiment of the present disclosure.

FIG. 22 is a cross-sectional view of flow channels in shape of octagon provided in an embodiment of the present disclosure.

FIG. 23 is a structural top view of flow channels with non-linearly, continuously changing widths provided in another embodiment of the present disclosure.

FIG. 24 is a structural top view of flow channels with stepwise changing widths provided in another embodiment of the present disclosure.

FIG. 25 is a structural side view of flow channels with linearly, continuously changing depths provided in another embodiment of the present disclosure.

FIG. 26 is a cross-sectional view taken along the line A-A of FIG. 25.

FIG. 27 is a cross-sectional view of a flow channel with a non-linearly, continuously changing depth provided in another embodiment of the present disclosure.

FIG. 28 is a cross-sectional view of a flow channel with a stepwise changing depth provided in another embodiment of the present disclosure.

FIG. 29 is a structural side view of flow channels with both changing widths and changing depths provided in another embodiment of the present disclosure.

FIG. 30 is a cross-sectional view of flow channels provided in another embodiment of the present disclosure.

FIG. 31 is a cross-sectional view of flow channels provided in yet another embodiment of the present disclosure.

FIG. 32 is a structural top view of a bipolar plate provided in another embodiment of the present disclosure.

FIG. 33 is a structural side view of flow channels with continuously changing depths and constant bottom thicknesses provided in another embodiment of the present disclosure.

FIG. 34 is a cross-sectional view of a bipolar plate provided in another embodiment of the present disclosure.

FIG. 35 is a structural side view of a bipolar plate provided in another embodiment of the present disclosure.

FIG. 36 is a schematic view of laser processing provided in another embodiment of the present disclosure.

### DETAILED DESCRIPTION

In order to make the above objectives, features, and advantages of the present disclosure more obvious and understandable, the specific embodiments of the present disclosure will be described in detail below with reference to the accompanying drawings. In the following description, many specific details are set forth in order to make the present disclosure fully understandable. However, the present disclosure can be implemented in many other ways different from those described herein, and those skilled in the art can make similar modifications without departing from the connotation of the present disclosure. Therefore, the present disclosure is not limited by the specific embodiments disclosed below.

The ordinal terms assigned to the elements in the present disclosure, such as “first”, “second”, etc., are merely used to distinguish the objects having the same name and do not connote any sequence or technical meaning. In the present disclosure, the terms “connecting” and “coupling”, in absence of a specific description, include the meanings of direct and indirect connecting (coupling). In the present disclosure, orientation or positional relationships indicated by the terms “upper”, “lower”, “front”, “rear”, “left”, “right”, “vertical”, “horizontal”, “top”, “bottom”, “inner”, “outer”, “clockwise”, “counterclockwise”, etc. are based on orientation or positional relationships shown in the accompanying drawings. These terms are used merely for facilitating the description of the present disclosure and simplifying the description, rather than indicating or implying that the described devices or elements must orient in the specific directions or be constructed and operated in the specific directions, and therefore are not construed as limitations to the scope of the present disclosure.

In the present disclosure, unless explicitly stated and defined otherwise, the first feature “above” or “below” the second feature can be that the first feature and the second feature are in direct contact, or that the first feature and the second feature are in indirect contact via an intermediate medium. Moreover, the first feature is “above” the second feature can be that the first feature is directly above or obliquely above the second feature, or it only indicates that a horizontal height of the first feature is greater than the horizontal height of the second feature. The first feature is “below” the second feature can be that the first feature can be directly below or obliquely below the second feature, or it can simply indicate that a horizontal height of the first feature is less than the horizontal height of the second feature.

In order to improve the gas transport performance and the drainage capacity of the flow channels, there is a need to provide a method for manufacturing a bipolar plate of the fuel cell.

A bipolar plate is the core components of fuel cells. Bipolar plates design is one of the main factors that determine the fuel cell performance. Structures such as cathode flow channels, anode flow channels, cooling flow channels, etc. are defined on surfaces of the bipolar plates. The cathode flow channels and anode flow channels undertake reactant gas distribution, cooling, and drainage functions in the fuel cells.

A graphite bipolar plate has excellent corrosion resistance and is usually used to prolong a lifespan of the fuel cell stack. In order to improve the performance of the bipolar plate, technicians are making every effort to decrease widths of ribs and increase distribution density of flow channels. The width and depth of a flow channel in a conventional bipolar plate are both about 1 mm, and can reach 0.4 mm by using some processing techniques. However, regardless of either by computer numerical control machining or by compression molding, further reducing the rib widths and increasing the distribution density of the flow channels face the problems of high cost and low efficiency.

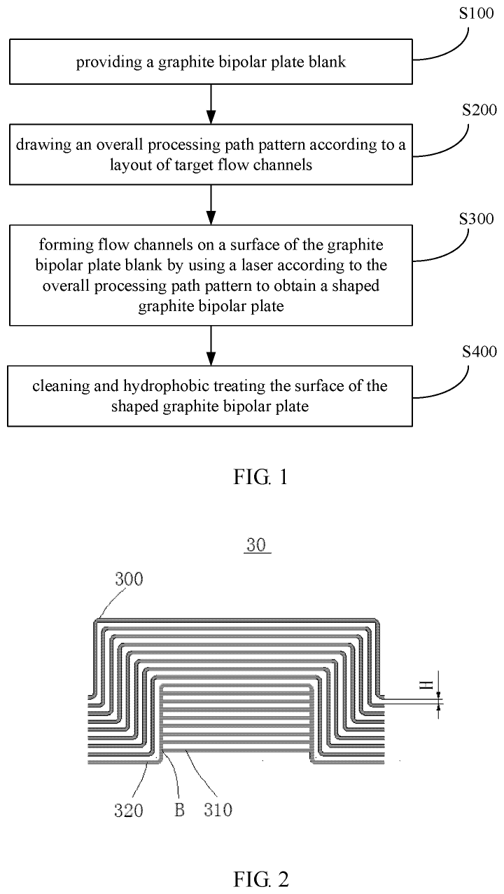

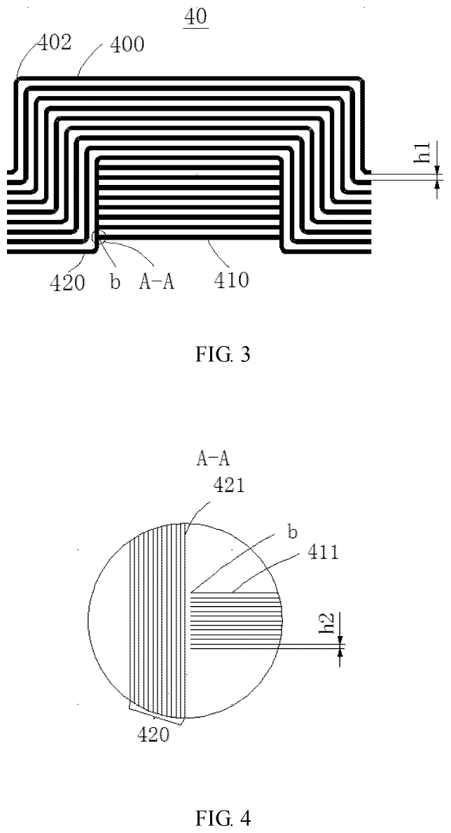

Referring to FIG. 1, FIG. 2 and FIG. 3, an embodiment of the present disclosure provides a manufacturing method for a bipolar plate of a fuel cell, including:
S100, providing a graphite bipolar plate blank;
S200, drawing an overall processing path pattern 40 according to a layout of target flow channels;
S300, forming flow channels on a surface of the graphite bipolar plate blank by using a laser according to the overall processing path pattern 40 to obtain a shaped graphite bipolar plate; and
S400, cleaning and hydrophobic treating the surface of the shaped graphite bipolar plate.

The method for manufacturing the bipolar plate of the fuel cell provided by the embodiment of the present disclosure, adopts the laser to form the flow channels on the graphite bipolar plate blank. According to the layout of the target flow channels, this method can obtain the shaped graphite bipolar plate. In the art known to the inventors, widths of the flow channel ribs processed by machining are in millimeter-scales, and widths of those processed by the compression molding are also in millimeter-scales. In the present disclosure, the manufacturing method adopts the laser to form the flow channels. The laser forms a light spot with a microscale diameter and does not generate mechanical stress. The laser can be used to form more densely distributed flow channels with narrower rib widths. Further, the manufacturing method includes a surface cleaning treatment and a surface hydrophobic treatment applied on the shaped graphite bipolar plate, and the flow channels after the surface hydrophobic treatment are not easy to accumulate water. Furthermore, the transporting ability of the flow channels of the bipolar plate formed by the manufacturing method is enhanced, and the manufacturing method improves the performance of the bipolar plate.

In an embodiment, the S100 includes: forming a bipolar plate rigid pristine blank; and forming an inflow port, an outflow port, and a flow channel common port on the surface of the bipolar plate rigid pristine blank by using a mechanical processing machine, thereby forming the graphite bipolar plate blank.

In another embodiment, the S100 includes: forming the graphite bipolar plate blank from graphite powder by compression molding, wherein the surface of the graphite bipolar plate blank defines the inflow port, the outflow port, the flow channel common port, and main flow channels. The main flow channels are directly formed by the compression molding. The main flow channels formed on the surface of the graphite bipolar plate blank are then finely processed by the S200 and S300 to improve the gas diffusion capability of the main flow channels.

The inflow port, outflow port, and flow channel common port of the bipolar plate are formed by the mechanical processing or the compression molding, thereby improving the processing efficiency.

The principle of the laser etching is that the graphite and resin materials on a path or route scanned by a high-energy laser beam are melted or burnt by the laser beam, thereby forming the flow channels or grooves.

In an embodiment, the S200 includes:
S210, obtaining a flow channel width, a flow channel depth, a flow channel extending shape, and a flow channel interval D of the target flow channels 300 according to the layout of the target flow channels;
S220, selecting a laser spot diameter and a laser scanning interval according to the flow channel width;
S230, selecting a laser scanning frequency, a laser scanning speed, and the number of processing times according to the flow channel depth; and
S240, obtaining the overall processing path pattern 40 according to the flow channel extending shape, the flow channel interval D, the laser spot diameter, and the laser scanning interval.

The flow channel interval D refers to the distance between adjacent side walls of two adjacent flow channels. The laser scanning interval refers to the distance between centers of two adjacent laser scanning spots. The two adjacent laser scanning spots are used to form two adjacent laser scanning lines.

Referring also to FIG. 4, in an embodiment, the S240 includes:
S241, obtaining shapes of laser scanning lines corresponding to the target flow channels 300 according to the flow channel extending shape, wherein the layout 1 of the target flow channels includes a plurality of the target flow channels 300. The overall processing path pattern 40 includes a plurality of scanning line groups 400, the plurality of scanning line groups 400 are in a one-to-one correspondence with the plurality of target flow channels 300, and each scanning line group 400 includes a plurality of the laser scanning lines;
S242, calculating the number of laser scanning times for forming each target flow channel 300 according to the laser spot diameter, the laser scanning interval, and the flow channel width, obtaining the number of the laser scanning lines according to the number of laser scanning times, and obtaining a corresponding scanning line interval h2 between two adjacent laser scanning lines according to the laser scanning interval, wherein the two adjacent laser scanning lines are located in one same scanning line group 400;
S243, obtaining a corresponding scanning line group interval hl between two adjacent scanning line groups 400 according to the flow channel interval D;
S244, obtaining the overall processing path pattern 40 according to the shapes of the laser scanning lines, the number of the laser scanning lines, the scanning line interval h2, and the scanning line group interval hl.

In S241, the plurality of laser scanning lines in one scanning line group 400 are parallel to each other. The shapes of the laser scanning lines each is selected from a straight-line shape, a broken-line shape, and an arc-line shape.

In S242, the number of the laser scanning times can be calculated from a laser scanning time calculating formula. The formula is n=(X−Y)/(p+1), wherein n represents the number of the laser scanning times, X represents the flow channel width, Y represents the laser spot diameter, and p represents the laser scanning interval.

The selection of the laser scanning interval is based on the laser processing characteristics of the graphite bipolar plate blank. The appropriate laser scanning interval can ensure both the processing speed and the surface roughness.

In an embodiment, before selecting the laser scanning interval, a preliminary experiment for determining the laser scanning interval is performed. The preliminary experiment includes laser processing for multiple times by using different laser scanning intervals, and measuring the processing accuracy of the flow channels.

In the above-described embodiment, the laser scanning interval p is equal to the scanning line interval h2.

In an embodiment, the S300 is forming the flow channels on the graphite bipolar plate blank by using the laser according to the laser spot diameter, the laser scanning frequency, the laser scanning speed, the number of processing times, and the overall processing path pattern 40 to obtain a shaped graphite bipolar plate.

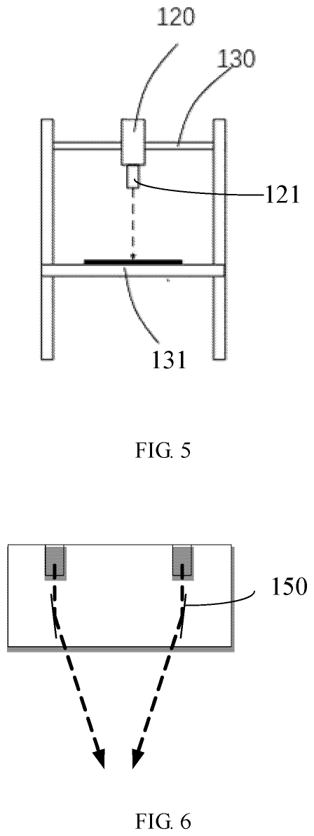

Referring also to FIG. 5, in an embodiment, a laser etching machine is used to process the graphite bipolar plate blank. The laser etching machine includes an overall control device, a laser generating device 120, a platform 131, and a moving structure 130. The laser generating device 120 and the moving structure 130 are respectively and electrically connected to the overall control device. The overall control device is configured to receive external instructions and control the laser generating device 120 to cooperate with the moving structure 130 according to the external instructions.

The laser generating device 120 is configured to generate a laser beam. The platform 131 is configured to fix the graphite bipolar plate blank and provide a processing platform. The moving structure 130 is fixedly connected to a probe 121 of the laser generating device 120, and is configured to drive the laser probe 121 to move according to the overall processing path pattern 40. The moving structure 130 is capable of performing a spatial three-dimensional movement.

In an embodiment, the step of processing the graphite bipolar plate blank by using the laser etching machine includes:
S1, fixing the graphite bipolar plate blank to the platform 131, wherein the graphite bipolar plate blank is marked with a processing origin, and the probe 121 is arranged corresponding to the processing origin of the graphite bipolar plate blank;
S2, setting the laser spot diameter, the laser scanning frequency, the laser scanning speed, and the number of processing times in the overall control device;
S3, importing the overall processing path pattern 40 into the overall control device; and
S4, controlling the laser generating device 120 to cooperate with the moving structure 130 by the overall control device, thereby forming the flow channels on the surface of the graphite bipolar plate blank.

Referring also to FIG. 6, in an embodiment, the laser etching machine further includes a refractor 150. The refractor 150 is arranged on a laser transmission path to change the direction of the laser beam. The laser etching machine can be used to form a variety of the target flow channels and spatial structures such as oblique bores, trapezoidal grooves, etc. formed in the ribs.

A rib is referred to the structure between two adjacent target flow channels 300. The above-described method is also used to process the ribs to form bores, grooves, or a combination thereof on the ribs.

In an embodiment, before the S230, the manufacturing method further includes:
S221, performing a preliminary experiment to determine the laser scanning frequency, the laser scanning speed, and the number of the processing times.

Since a proportion of non-graphite components, such as resins, may be different among graphite plates, the laser scanning frequency, the laser scanning speed, and the number of processing times can be determined by the preliminary experiment. When selecting and determining a specific scanning parameter, it needs to coordinate the relationship between machining accuracy, surface roughness, and the scanning parameter.

In an embodiment, the S221 includes:
S11, providing an experimental graphite bipolar plate blank, wherein the experimental graphite bipolar plate blank is substantially identical to the graphite bipolar plate blank to be processed;
S12, laser scanning the experimental graphite bipolar plate blank along a first straight line at the laser scanning frequency and the laser scanning speed for N times, i.e., a first experimental number of processing times is N, to form a first groove, and measuring a depth of the first groove to obtain a first depth;
S13, laser scanning the experimental graphite bipolar plate blank along a second straight line at the laser scanning frequency and the laser scanning speed for M times, i.e., a second experimental number of processing times is M, to form a second groove, and measuring a depth of the second groove to obtain a second depth, where M is greater than N, and M and N are positive integers;
S14, determine the number of processing times according to the first depth, the second depth, M, N, and the flow channel depth.

In an embodiment, in the S14, according to the first depth, the second depth, M, N, and the flow channel depth, a difference method is used to determine the number of processing times to improve scan accuracy.

The faster the laser scanning, the faster the overall processing. The selection of the laser scanning speed depends on the processing accuracy of the machine and the designs of the flow channels. When there is a need to form complex structures, such as vertical structures, multiple break points, multiple processing paths, and a micro flow channel structure with the same size as the light spot in forming the flow channels, the laser scanning can be performed at varied speeds. A first laser scanning speed can be adopted to form a straight flow channel. A second laser scanning speed can be adopted to form a flow channel with a complex structure. The first laser scanning speed is greater than the second laser scanning speed.

In an embodiment, in the S300, a high-energy laser is used to process the graphite bipolar plate blank to form the flow channels. When the graphite bipolar plate is processed by the high-energy laser, the material of the graphite bipolar plate blank is plasmaized into a plasma state, thereby avoiding residue accumulation and machining defects. The shorter the time of a laser pulse, the higher the overall energy, which is more conducive to the plasmaization. The energy of a low-frequency pulsed laser is not high enough to plasmaize graphite.

The depth of the laser processed flow channel corresponds to the volume of graphite that can be melted or burnt per unit time-period by the laser. The flow channel processing is to balance the processing speed and accuracy. The greater the laser energy, the faster the scanning, the faster the processing, and the lower the accuracy.

In an embodiment, the high-energy laser is a picosecond laser, a femtosecond laser, or a nanosecond laser.

The manufacturing method for the bipolar plate of the fuel cell adopts a laser with a small laser spot diameter ranged from 10 microns to 200 microns. Since the energy distribution of the laser spot follows the Gaussian distribution, the closer to the center of the laser spot, the higher the laser energy. A small light spot can reduce the difference in energy distribution and improve the processing accuracy.

In an embodiment, in the S300, a fiber laser is used to process the graphite bipolar plate blank to form the flow channels. The laser used for processing graphite has a relatively high energy and a relatively short wavelength. CO2 laser has a relatively long wavelength and low energy, so it may be not suitable for processing graphite. The fiber laser has a short wavelength and a high energy, which is suitable for processing graphite.

In the S300, a laser with a shorter wavelength than the fiber laser can also be used.

In an embodiment, in the S241, the step of obtaining the shapes of the laser scanning lines corresponding to the target flow channels 300 according to the extending shapes of the target flow channels 300 further includes:
S21, determining whether the target flow channel 300 includes a corner structure;
S22, if yes, setting a rounded corner structure 402 corresponding to the corner structure in the laser scanning line.

In an embodiment, the target flow channel 300 includes a right-angled flow channel structure, and the right-angled flow channel structure is designed as the rounded corner structure 402 to avoid repeated processing at a local position and improve the processing accuracy.

In an embodiment, the plurality of target flow channels 300 include first target flow channels 310 and second target flow channels 320. The plurality of scanning line groups 400 include first scanning line groups 410 and second scanning line groups 420. Each first scanning line group 410 includes a plurality of first laser scanning lines 411. The first laser scanning lines 411 correspond to the same first target flow channel 310. Each second scanning line group 420 includes a plurality of second laser scanning lines 421. The second laser scanning lines 421 correspond to the same second target flow channel 320. In S241, the step of obtaining the shapes of the laser scanning lines corresponding to the target flow channels 300 according to the extending shape of the target flow channels 300 further includes:
S31, determining whether a starting point B of the first target flow channel 310 overlaps with the extending path of the second target flow channel 320;
S32, if yes, setting a machining allowance gap at a starting point b of the first laser scanning line.

If the first laser scanning line 411 is overlapped with the second laser scanning line 421, the overlapped position is scanned twice by the laser beam, and therefore the depth at the overlapped position is greater than the depth at other positions. By setting the machining allowance gap, a gap is formed between the starting point b of the first laser scanning line 411 and the second laser scanning line 421 to ensure that the center of the laser spot does not repeatedly scan the position of the gap and improve the processing accuracy. The size of the gap is substantially equal to the radius of the laser spot.

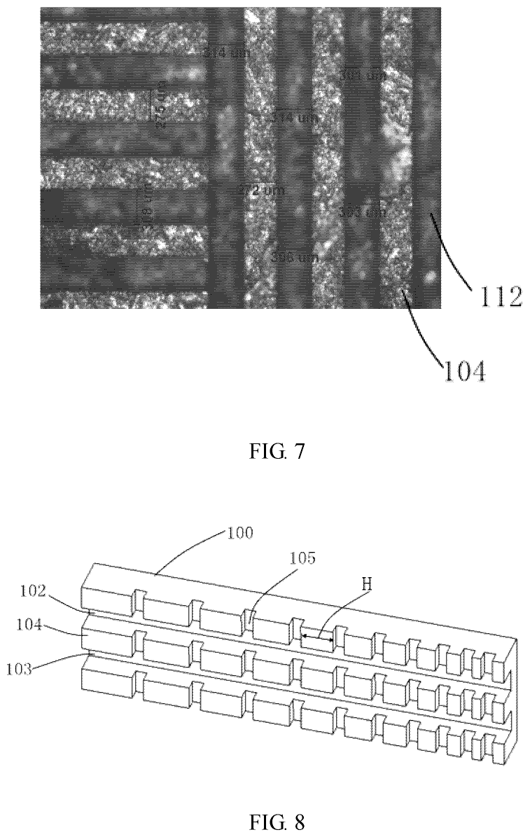

Referring also to FIG. 7, in an embodiment, an ordinary expanded graphite plate and an 80W picosecond laser are used in an experiment. The laser scanning speed is fixed to 1 m/s. In the preliminary experiment, a test groove with a depth of about 0.2 mm is formed by performing 100 times of the laser scanning in 50% of the laser energy, and another test groove with a depth of about 0.75 mm is formed by performing 500 times of the laser scanning in 40% of the laser energy. Through the difference method, it is determined that each laser scanning line is scanned for 150 times by the laser with 50% of the laser energy to obtain the flow channel with a depth of 0.3 mm.

In an embodiment, the target flow channel has a width of 0.3 mm and a depth of 0.3 mm. Based on the result of the preliminary experiment, the final design of the flow channel is as follows:

The laser spot diameter is 50 μm; the laser scanning interval is 20 μm; the laser scanning frequency is 300 kHz; the number of processing times is 150 per laser scanning line; the laser scanning speed is 1 m/s; the laser energy is 50% (of 80W as the maximum energy).

FIG. 7 is a photograph of the flow channels of a shaped graphite bipolar plate obtained by adopting the above-described parameters.

The bottom of the formed flow channels 112 has good flatness. A rib 104 is formed between two adjacent flow channels 112.

A fuel cell undergoes electrochemical reactions in operation and generates water on the cathode catalyst layer. The generated water flows into the flow channels through the gas diffusion layer and is taken away by the reactant gas in the flow channels. The reactant gas flows through the flow channels and the gas diffusion layer. In contrast to the insides of the flow channels, the contact areas between the ribs and the cathode gas diffusion layer hinder the water in the gas diffusion layer from entering the flow channels. The accumulation of the water in the contact areas hinder the mass transfer of the reactant gas from the flow channels to the catalyst layer, thereby affecting the performance of the fuel cell.

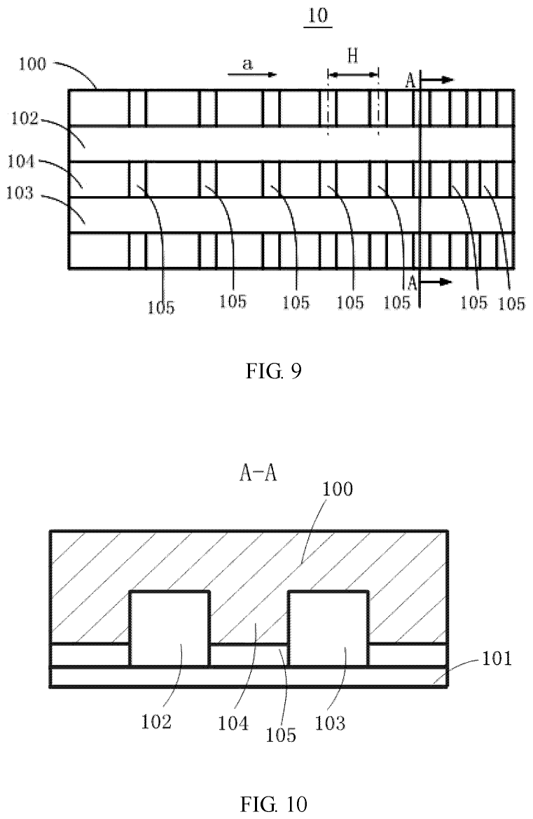

Referring to FIG. 8, FIG. 9 and FIG. 10, an embodiment of the present disclosure provides the fuel cell bipolar plate 10. The bipolar plate 10 includes a substrate 100. A surface of the substrate 100 defines a first flow channel 102 and a second flow channel 103 adjacent to the first flow channel 102. A rib 104 is formed between the first flow channel 102 and the second flow channel 103. A top surface of the rib 104 defines one or more grooves 105. One or both of the first flow channel 102 and the second flow channel 103 are in fluid communication with the grooves 105.

Water accumulated at a contact area between the rib 104 and the cathode gas diffusion layer 101 flows into the grooves 105, then flows into the first flow channel 102 or the second flow channel 103 from the grooves 105, and is finally carried away by the reactant gas. The grooves 105 effectively avoid water accumulation at the local area, thereby improving the drainage performance of the fuel cell. In the bipolar plate 10, the flow rate of the reactant gas at the local area is increased, the mass transfer efficiency of the reactant gas in the gas diffusion layer is increased, and the performance of the fuel cell is therefore improved. Further, the grooves 105 reduce the contact area between the rib 104 and the gas diffusion layer 101, and increase an effective area of gas diffusion in the gas diffusion layer 101, thereby improving the performance of the fuel cell.

A cross-section of the groove 105 can be polygon-shaped, circular-shaped, or partially arc-shaped. The grooves 105 are in fluid communication with the first flow channel 102 or the second flow channel 103 and introduce the water adjacent to the grooves 105 into the first flow channel 102 or the second flow channel 103, which reduces water accumulation at the local area, increases a contact probability of gases, hydrogen ions, and electrons, and further improves the performance of the fuel cell. The depths and widths of the grooves 105 can be varied to adapt to different flow channel widths and depths.

When the fuel cell is in operation, an electrochemical reaction occurs on the cathode catalyst layer to generate water. The water enters the cathode flow channels through the cathode gas diffusion layer, or diffuses to the anode through the proton exchange membrane and then enters the anode flow channels through the anode gas diffusion layer. Driven by the reactant gas flows, the water in the flow channels moves to the outlet ends of the flow channels. The amount of water in the flow channels gradually increases along the flowing direction of the gas. The water amount at the outlet end of the flow channel is greater than the water amount at the inlet end of the flow channel. Membrane dryness is prone to occur at the local area adjacent to the inlet ends of the flow channels, and flooding is prone to occur adjacent to the outlet ends of the flow channels. Lack of water will decrease the conductivity of the proton exchange membrane. Too much water will block the channels through which the reactant gas flows, decreasing the gas diffusion rate of the gas in the gas diffusion layer. The decrease in the gas diffusion rate leads to a decrease in the electrochemical reaction rate, and the performance of the fuel cell decreases. In order to make the reactant gas flow along the flow channels, the gas pressure at the inlet ends is greater than the gas pressure at the outlet ends.

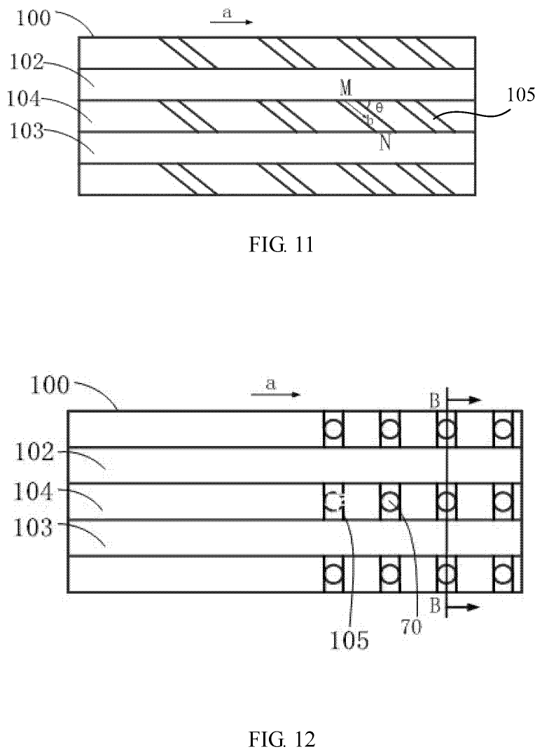

Referring also to FIG. 11, in an embodiment, the first flow channel 102 and the second flow channel 103 are configured to transport identical reactant gas along a first direction a. The grooves 105 extend along a second direction b. An angle θ between the second direction b and the first direction a is an acute angle.

An opening end of each groove 105 adjacent to the first flow channel 102 is M. An opening end of the groove 105 adjacent to the second flow channel 103 is N. As the first flow channel 102 and the second flow channel 103 are configured to transport identical reactant gas along the first direction a, the opening end M is adjacent to the inlet ends of the flow channels, and the opening end N is adjacent to the outlet ends of the flow channels. As the gas pressure at the inlet ends is greater than the pressure at the outlet ends, the gas pressure at the opening end M is greater than that at the opening end N. Driven by the pressure difference, the liquid state water on the surface of the gas diffusion layer moves into the second flow channel 103, and continuously gathers at the outlet end, and is taken away by the reactant gas.

Generally, the width of each flow channel in the flow field of the bipolar plate is ranged from about 0.4 mm to about 1.5 mm, and the depth of the flow channel is about 0.4 mm to 1.5 mm. The pressure drop between an inlet end and an outlet end of an anode flow channel is about tens of kilopascals. In a specific embodiment, taking the anode as an example, the width and depth of the flow channel are both 1 mm, the width of the rib is 1 mm, and the angle θ defined between the length direction of the oblique groove and the length direction of the flow channel is 45°. Taking the pressure drop between the inlet end and the outlet end of the flow channel as 30 kPa, for a flow channel with a total length of 300 mm, the pressure difference between the two ends of the oblique groove is 30 kPa/300=100 Pa.

In an embodiment, a plurality of grooves 105 are defined on the top surface of each rib 104. Along the first direction a, the plurality of grooves 105 are arranged at intervals to increase the number of the grooves 105 as the flow-guiding channels and increase the drainage rate. Further, the plurality of grooves 105 reduce the contact area between each rib 104 and the gas diffusion layer and increase the contact area of air, hydrogen ions, and electrons, thereby improving the performance of the fuel cell.

In an embodiment, a distance H between two adjacent grooves 105 gradually decreases along the first direction a. Membrane dryness is prone to occur at the place adjacent to the inlet end of the flow channel, and local flooding is prone to occur at the local area adjacent to the outlet end of the flow channel. Adjacent to the outlet end of the flow channel, the distance H between the adjacent grooves 105 decreases, and the number of the grooves 105 increases, which can increase the number of the grooves 105 as the flow-guiding channels and increase the drainage rate. Adjacent to the inlet end of the flow channel, the number of grooves 105 decreases, which can reduce the area directly subjected to the gas flow and avoid local membrane dryness.

In an embodiment, no groove 105 is located adjacent to the inlet end, and a plurality of grooves 105 are located adjacent to the outlet end, to avoid the local membrane dryness at the inlet end and the local flooding at the outlet end.

In an embodiment, the extending directions of the plurality of grooves 105 are different, and the included angle θ between the extending directions and the first direction a gradually decreases along the gas flowing direction. That is, the angle θ corresponding to the groove 105 adjacent to the inlet end is relatively large, and the angle θ corresponding to the groove 105 adjacent to the outlet end is relatively small. The smaller the included angle θ, the greater the component of the groove 105 in the length direction of flow channel, the greater the pressure difference between the opening end M and the opening end N, and the greater the drainage rate. Membrane dryness is prone to occur at the local area adjacent to the inlet end of the flow channel, and flooding is prone to occur adjacent to the outlet end of the flow channel. The closer to the outlet end, the smaller the included angle θ, the greater the pressure difference, and the greater the drainage rate. The closer to the inlet end, the larger the included angle θ, the smaller the pressure difference, which avoids the local membrane dryness.

In an embodiment, along the first direction a, the distance H between two adjacent grooves 105 gradually decreases, and the included angle θ gradually decreases. Adjacent to the outlet end of the flow channel, the number of the grooves 105 as the drainage channels increases, and the pressure difference between the opening end M and the opening end N increases, which increases the drainage rate and avoids the local flooding at the outlet end of the flow channel.

Referring also to FIG. 12, in an embodiment, a first bore 70 is defined in the bottom of each groove 105. The first bore 70 is in fluid communication with the first flow channel 102 to improve fluid circulation and improve the drainage efficiency.

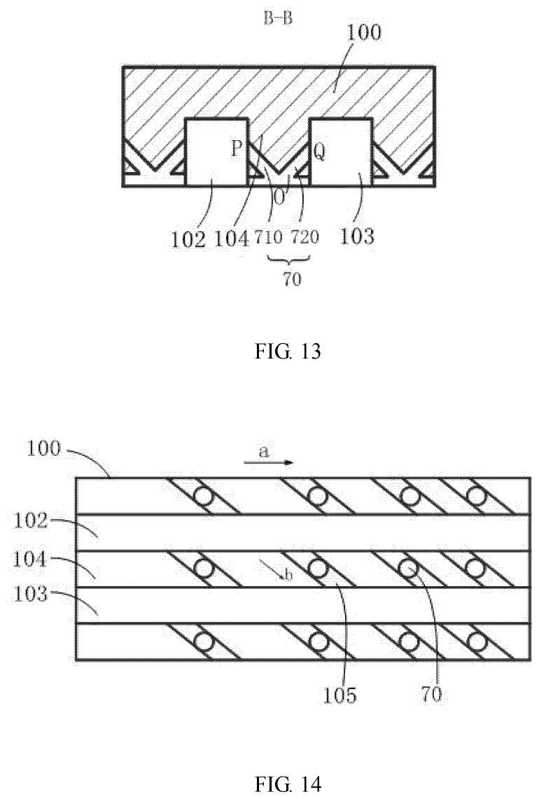

Referring to FIG. 12 and FIG. 13, in an embodiment, the first bore 70 includes a first tunnel 710 and a second tunnel 710 intersected with each other. The first tunnel 710 is in fluid communication with the first flow channel 102. The second tunnel 710 is in communication with the second flow channel 103. An opening end O of the first bore 70 is located on the bottom surface of the groove 105, an opening end P of the first bore 70 is located at the first flow channel 102, and an opening end Q of the first bore 70 is located at the second flow channel 103.

In an embodiment, the opening end P and the opening end Q are identical in shape, and are symmetrically located about the opening end O.

The angle between the extending direction of the first flow channel 102 and the first direction a is the first angle. The angle between the extending direction of the second flow channel 103 and the first direction a is the second angle. The first angle and the second angle can be the same or different.

Referring also to FIG. 14, in an embodiment, the grooves 105 are oblique structure, which increases the pressure difference between the opening ends of the grooves 105 and increases the drainage rate.

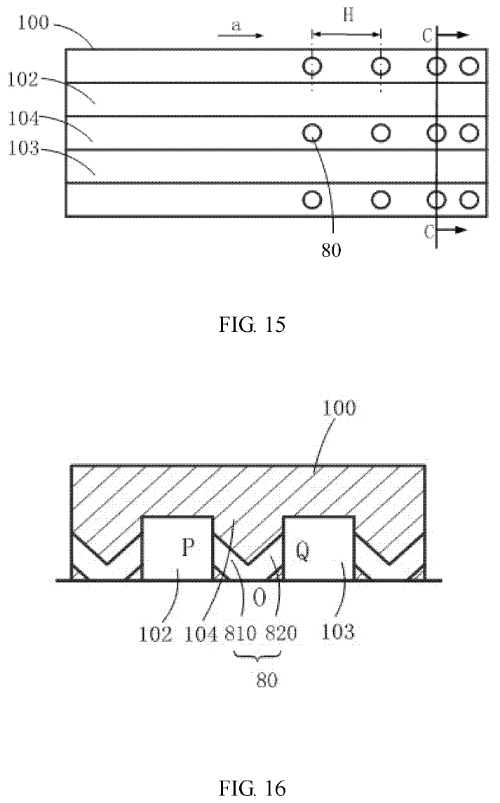

Referring to FIG. 15 and FIG. 16, an embodiment of the present disclosure provides the fuel cell bipolar plate 10. The bipolar plate 10 includes a substrate 100. A surface of the substrate 100 defines a first flow channel 102 and a second flow channel 103 adjacent to the first flow channel 102. A rib 104 is formed between the first flow channel 102 and the second flow channel 103. A second bore 80 is defined on the top surface of the rib 104, and the second bore 80 is in fluid communication with the first flow channel 102.

The bipolar plate 10 provided by the embodiment of the present disclosure includes the substrate 100. The second bore 80 is defined on the top surface of the rib 104, and the second bore 80 is in fluid communication with the first flow channel 102. The water will flow into the second bore 80, and then flow into the first flow channel 102 or the second flow channel 103 from the second bore 80, and is taken away by the reactant gas. As such, the second bore 80 effectively avoids water accumulation at the local area. The bipolar plate 10 increases the circulation velocity of the reactant gas at the local area, increases a contact probability of gases, hydrogen ions, and electrons, and further improves the performance of the bipolar plate of the fuel cell. Further, the second bore 80 reduces the contact area between the rib 104 and the gas diffusion layer, increases the contact area of air, hydrogen ions, and electrons, thereby improving the performance of the fuel cell.

In an embodiment, the second bore 80 includes a third tunnel 810 and a fourth tunnel 820 intersected with each other. The third tunnel 810 is in fluid communication with the first flow channel 102. The fourth tunnel 820 is in fluid communication with the second flow channel 103. An opening end O of the second bore 80 is located on the top surface of the rib 104, an opening end P of the second bore 80 is located at the first flow channel 102, and an opening end Q of the second bore 80 is located at the second flow channel 103.

In an embodiment, the opening end P and the opening end Q are identical in sectional shape, and are symmetrically located about the opening end O. The gas pressure at the opening end P is equal to the gas pressure at the opening end Q.

In an embodiment, along the first direction a, a distance from the opening end P to the outlet end is greater than a distance from the opening end Q to the same outlet end, which increases the pressure difference between the opening end P and the opening end Q, and therefore improves the drainage efficiency and the performance of the bipolar plate.

In an embodiment, a plurality of second bores 80 are defined on the top surface of each rib 104. Along the first direction a, the plurality of second bores 80 are arranged at intervals to increase the number of the second bores 80 as the flow-guiding channels and increases the drainage rate. Further, the plurality of second bores 80 reduce the contact area between each rib 104 and the gas diffusion layer and increase the contact area of air, hydrogen ions, and electrons, thereby improving the performance of the fuel cell.

In an embodiment, a distance H between two adjacent second bores 80 gradually decreases along the first direction a. Membrane dryness is prone to occur at the place adjacent to the inlet end of the flow channel, and flooding is prone to occur at the local area adjacent to the outlet end of the flow channel. Adjacent to the outlet end, the distance H between the adjacent second bores 80 decreases, and the number of the second bores 80 increases, which can increase the number of the second bores 80 as the flow-guiding channels and increase the drainage rate. Adjacent to the inlet end, the number of second bores 80 decreases, which can reduce the area directly subjected to the gas flow and avoid local membrane dryness.

In an embodiment, no second bore 80 is located adjacent to the inlet end, and the plurality of second bores 80 are located adjacent to the outlet end, to avoid the local membrane dryness at the inlet end and the local flooding at the outlet end.

A laser etching method is used in the manufacturing method for the bipolar plate 10 in any one of the above-described embodiments. The manufacturing method includes: firstly forming the flow channels with the rectangular cross-sections by molding or machining, and then forming the grooves 105, the first bores 70, or the second bores 80 by using an ultrafast laser. The laser processing is flexible, the power of laser is continuously adjustable, and no mechanical stress is generated during the processing, so that the shape of the removed material can be various, and various bipolar plates 10 of the fuel cells can be processed.

When the fuel cell is in operation, an electrochemical reaction occurs on the cathode side of the bipolar plate to generate water. Driven by the reactant gas flows, the water in the flow channels moves to the outlet end of the flow channels 112. The amount of water in the flow channels gradually increases along the flowing direction of the gas. The water amount at the outlet end 122 of the flow channel 112 is greater than the water amount at the inlet end 121 of the flow channel 112. Membrane dryness is prone to occur at the local area adjacent to the inlet ends 121 of the flow channels 112, and flooding is prone to occur at the local area adjacent to the outlet ends 122 of the flow channels 112. Too much water will decreases the gas diffusion rate of the gas in the gas diffusion layer, whereas lack of water will increase the proton transfer resistance of the proton exchange membrane, both of which will increase polarization loss and deteriorate performance of the fuel cell.

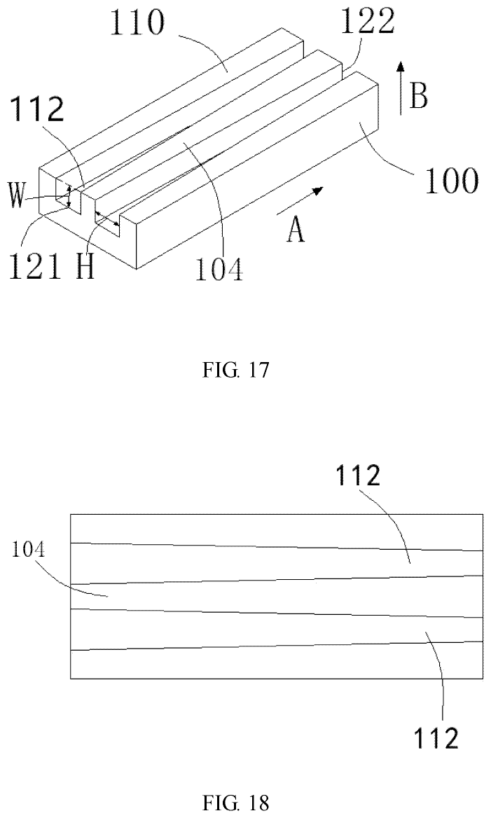

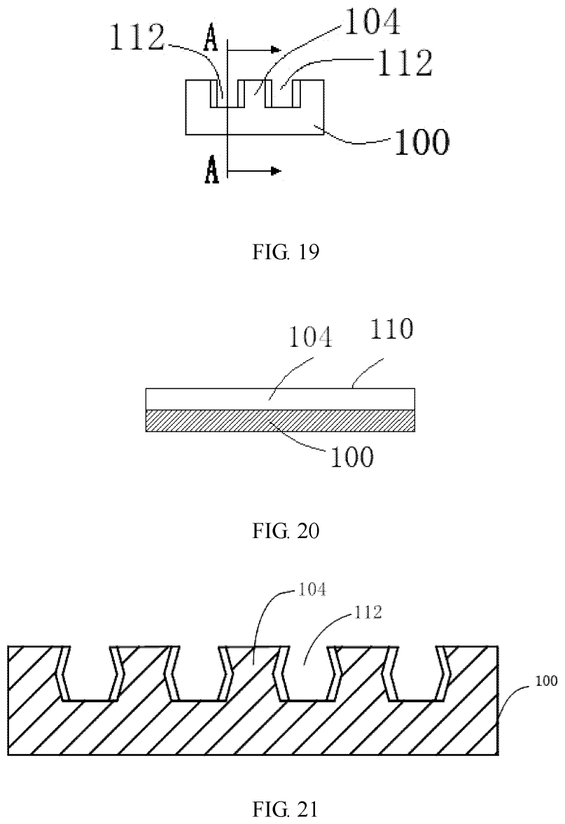

Referring to FIG. 17, FIG. 18, FIG. 19, and FIG. 20, an embodiment of the present disclosure provides the fuel cell bipolar plate 10, and the bipolar plate 10 includes a substrate 100. The substrate 100 includes a first surface 110. The first surface 110 defines flow channels 112. The flow channels 112 are configured to transport the reactant gas. The cross-section of each flow channel 112 gradually decreases in size along a reactant gas transport direction A in the flow channel 112.

In the bipolar plate 10 provided by the embodiment of the present disclosure, the amount of the reactant gas in the flow channel 112 is constant. Along the reactant gas transport direction A in the flow channel 112, the cross-sectional area of the flow channel 112 gradually decreases, the flow rate of the reactant gas gradually increases, and the flow rate of the water in the flow channel 112 gradually increases. The bipolar plate 10 makes the water flow rate match the water amount at every position of the flow channel 112, effectively avoiding the local membrane dryness and the local flooding. The bipolar plate 10 prevents water accumulation in the gas diffusion layer and avoids over drying the proton exchange membrane as well, which reduces the internal polarization loss of the fuel cell and improves the performance of the fuel cell.

In an embodiment, along the reactant gas transport direction A, the area of the cross-section of the flow channel 112 linearly, continuously decreases.

In an embodiment, along the reactant gas transport direction A, the area of the cross-section of the flow channel 112 non-linearly, continuously decreases.

The decrease of the area of the cross-section of the flow channel 112 satisfies a polynomial function, an exponential function, a logarithmic function, etc., or other irregularly continuous-decreased functions.

In an embodiment, along the reactant gas transport direction A, the area of the cross-section of the flow channel 112 gradually, stepwise decreases.

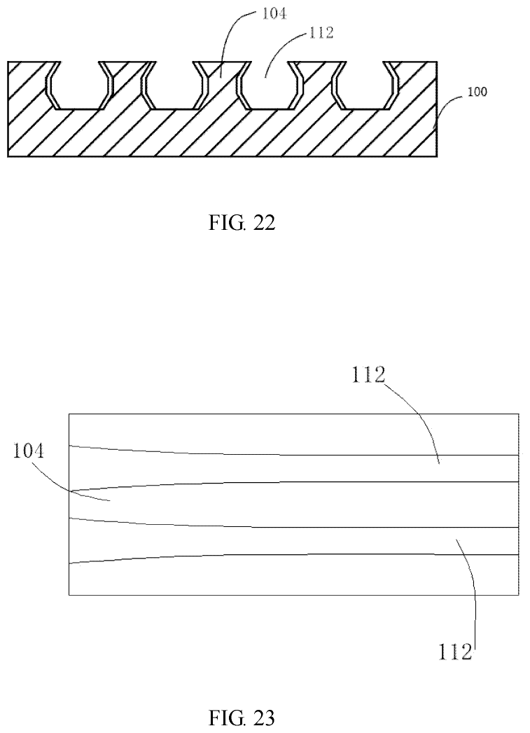

Referring to FIG. 21 and FIG. 22, in an embodiment, the shape of the cross-section of the flow channel 112 is a quadrilateral, a hexagon, an octagon, a decagon, or other polygons. Along the transport direction A, the maximum width W of the cross-section of the flow channel 112 gradually decreases, and the maximum depth H of the cross-section of the flow channel 112 is constant.

In an embodiment, the shape of the cross-section of the flow channel 112 is a quadrilateral, a hexagon, an octagon, a decagon, or other polygons. Along the transport direction A, the maximum width W of the cross-section of the flow channel 112 linearly, continuously decreases, and the maximum depth H of the cross-section of the flow channel 112 is constant.

In an embodiment, the shape of the cross-section of the flow channel 112 is a quadrilateral, a hexagon, an octagon, a decagon, or other polygons. Along the transport direction A, the maximum width W of the cross-section of the flow channel 112 non-linearly, continuously decreases, and the maximum depth H of the cross-section of the flow channel 112 is constant.

In an embodiment, the shape of the cross-section of the flow channel 112 is a quadrilateral, a hexagon, an octagon, a decagon, or other polygons. Along the transport direction A, the maximum width W of the cross-section of the flow channel 112 stepwise decreases, and the maximum depth H of the cross-section of the flow channel 112 is constant.

In an embodiment, the shape of the cross-section of the flow channel 112 is a quadrilateral, a hexagon, an octagon, a decagon, or other polygons. Along the transport direction A, the maximum width W of the cross-section of the flow channel 112 is constant, and the maximum depth H of the cross-section of the flow channel 112 gradually decreases.

In an embodiment, the shape of the cross-section of the flow channel 112 is a quadrilateral, a hexagon, an octagon, a decagon, or other polygons. Along the transport direction A, the maximum depth H of the cross-section of the flow channel 112 linearly, continuously decreases, and the maximum width W of the cross-section of the flow channel 112 is constant.

In an embodiment, the shape of the cross-section of the flow channel 112 is a quadrilateral, a hexagon, an octagon, a decagon, or other polygons. Along the transport direction A, the maximum depth H of the cross-section of the flow channel 112 non-linearly, continuously decreases, and the maximum width W of the cross-section of the flow channel 112 is constant.

In an embodiment, the shape of the cross-section of the flow channel 112 is a quadrilateral. Along the transport direction A, the maximum width W of the cross-section of the flow channel 112 gradually decreases, and the maximum depth H of the cross-section of the flow channel 112 is constant.

In an embodiment, the shape of the cross-section of the flow channel 112 is a rectangle.

Along the transport direction A, the maximum width W of the cross-section of the flow channel 112 linearly, continuously decreases, and the maximum depth H of the cross-section of the flow channel 112 is constant.

Referring also to FIG. 23, in an embodiment, the shape of the cross-section of the flow channel 112 is a rectangle. Along the transport direction A, the width W of the cross-section of the flow channel 112 non-linearly, gradually decreases, and the depth H of the cross-section of the flow channel 112 is constant.

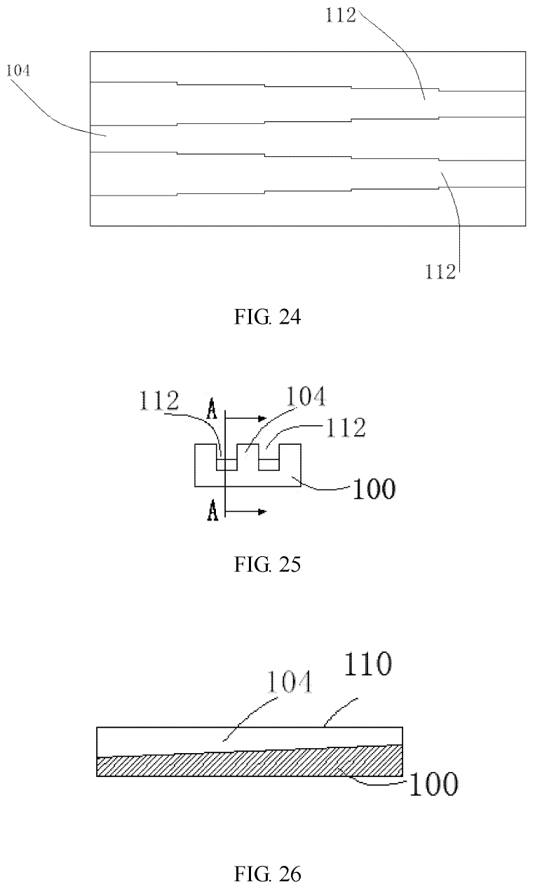

Referring also to FIG. 24, in an embodiment, the shape of the cross-section of the flow channel 112 is a rectangle. Along the transport direction A, the width W of the cross-section of the flow channel 112 stepwise, gradually decreases, and the depth H of the cross-section of the flow channel 112 is constant.

Referring to FIG. 25 and FIG. 26, in an embodiment, the shape of the cross-section of the flow channel 112 is a rectangle. Along the transport direction A, the depth H of the cross-section of the flow channel 112 gradually decreases, and the width W of the cross-section of the flow channel 112 is constant.

In an embodiment, the shape of the cross-section of the flow channel 112 is a rectangle. Along the transport direction A, the depth H of the cross-section of the flow channel 112 linearly, continuously decreases, and the width W of the cross-section of the flow channel 112 is constant.

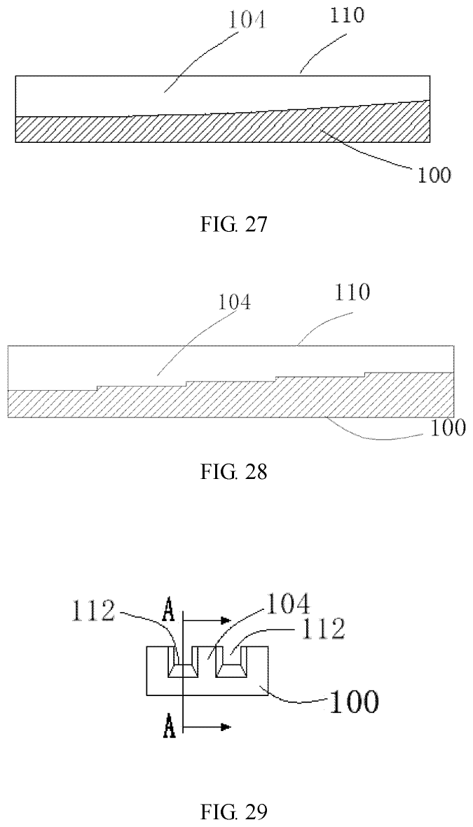

Referring also to FIG. 27, in an embodiment, the shape of the cross-section of the flow channel 112 is a rectangle. Along the transport direction A, the depth H of the cross-section of the flow channel 112 non-linearly, continuously decreases, and the width W of the cross-section of the flow channel 112 is constant.

Referring also to FIG. 28, in an embodiment, the shape of the cross-section of the flow channel 112 is a rectangle. Along the transport direction A, the depth H of the cross-section of the flow channel 112 stepwise, gradually decreases, and the width W of the cross-section of the flow channel 112 is constant.

Referring also to FIG. 29, in an embodiment, the shape of the cross-section of the flow channel 112 is a rectangle. Along the transport direction A, the depth H of the cross-section of the flow channel 112 gradually decreases, and the width W of the cross-section of the flow channel 112 gradually decreases.

In the above-described embodiment, the gradual decrease of the depth H of the cross-section of the flow channel 112 can be one of linear continuous decrease, non-linear continuous decrease, or stepwise decrease; the gradual decrease of the width W of the cross-section of the flow channel 112 can be one of linear continuous decrease, non-linear continuous decrease, or stepwise decrease.

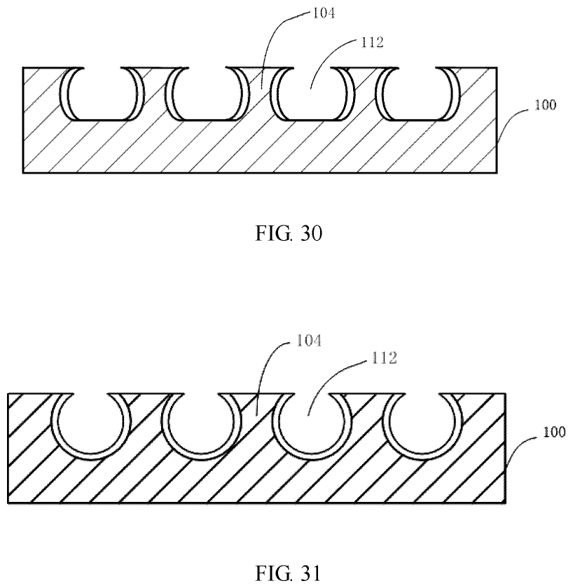

Referring also to FIG. 30, in an embodiment, the sidewall of the flow channel 112 is arc-shaped. The rib 104 is formed between two adjacent flow channels 112, and the arc is bent toward the rib 104.

Referring also to FIG. 31, in an embodiment, the bottom surface of the flow channel 112 is arc-shaped, and the bottom surface of the flow channel 112 is bent toward the substrate.

In an embodiment, the side wall or the bottom surface of the flow channel 112 is arc-shaped. Along the transport direction A, the shape of the cross-section of the flow channel 112 remains unchanged, the maximum diameter or width of the flow channel 112 gradually decreases, and the maximum depth H of the flow channel 112 is constant.

In an embodiment, the maximum diameter or width of the flow channel 112 linearly continuously decreases, non-linearly continuously decreases, or decreases stepwise.

In an embodiment, the side wall or the bottom surface of the flow channel 112 is arc-shaped. Along the transport direction A, the shape of the cross-section of the flow channel 112 remains unchanged, the maximum depth H of the flow channel 112 gradually decreases, and the maximum diameter or width of the flow channel 112 is constant. The maximum depth H of the flow channel 112 linearly continuously decreases, non-linearly continuously decreases, or decreases stepwise.

In an embodiment, along the length direction of the flow channel 112, the area of the cross-section of a section of the flow channel 112 gradually decreases. The flow channel 112 includes the inlet end, a middle section, and the outlet end.

In an embodiment, along the transport direction A, only the inlet end section of the flow channel 112 gradually decreases in the cross-sectional area, and the area of the cross-section of the middle section and the outlet end section of the flow channel 112 is constant. The cross-sectional area of the inlet end section of the flow channel 112 gradually decreases in the form the above-described cross-sectional area decreases.

In an embodiment, along the transport direction A, only the middle section of the flow channel 112 gradually decreases in the cross-sectional area, and the area of the cross-section of the inlet end section and the outlet end section of the flow channel 112 is constant. The cross-sectional area of the middle section of the flow channel 112 gradually decreases in the form the above-described cross-sectional area decreases.

In an embodiment, along the transport direction A, only the outlet end section of the flow channel 112 gradually decreases in the cross-sectional area, and the area of the cross-section of the middle section and the inlet end section of the flow channel 112 is constant. The cross-sectional area of the outlet end section of the flow channel 112 gradually decreases in the form the above-described cross-sectional area decreases.

In an embodiment, along the reactant gas transport direction A, the cross-section of the flow channel 112 can be changed in shape as long as the area of the cross-section of the flow channel 112 gradually decreases.

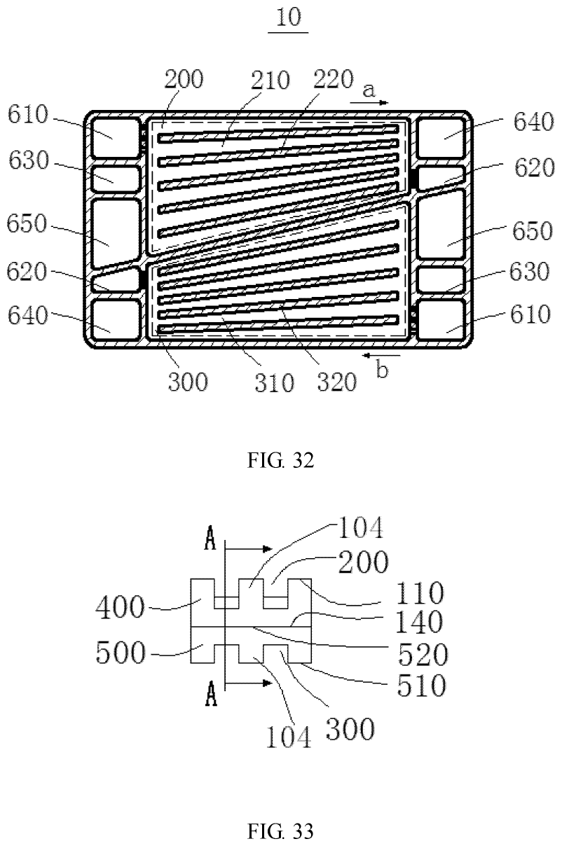

Referring to FIG. 32, an embodiment of the present disclosure provides the fuel cell bipolar plate 10, and the bipolar plate 10 includes a substrate 100. The substrate 100 includes a first surface 110. The first surface 110 defines a third flow channel unit 200. The third flow channel unit 200 includes a plurality of third flow channels 210 arranged side by side. A first rib 220 is formed between two adjacent third flow channels 210. The plurality of the third flow channels 210 are configured to transport the reactant gas along the first direction a. The shape of the cross-section of each third flow channel 210 is rectangular. Along the first direction a, the widths W of the plurality of first ribs 220 are equal to each other, the width W of the cross-section of each third flow channel 210 gradually decreases, and the depth H of the cross-section of each third flow channel 210 is constant.

In the bipolar plate 10 provided by the embodiment of the present disclosure, the amount of the reactant gas in the third flow channel 210 is constant. Along the first direction a, the widths W of the plurality of first ribs 220 are equal to each other, the width W of the cross-section of each third flow channel 210 gradually decreases, and the depth H of the cross-section of each third flow channel 210 is constant. The area of the cross-section of each third flow channel 210 gradually decreases, so that the flow rate of the reactant gas gradually increases, and the flow rate of the water in the third flow channel 210 gradually increases. The bipolar plate 10 makes the water flow rate match the water amount at every position of the flow channel 112, effectively avoiding the local membrane dryness and the local flooding. The bipolar plate 10 prevents water accumulation in the gas diffusion layer and avoids over drying the proton exchange membrane as well, which reduces the internal polarization loss of the fuel cell and improves the performance of the fuel cell.

In an embodiment, the first surface 110 also defines a fourth flow channel unit 300. The fourth flow channel unit 300 includes a plurality of fourth flow channels 310 arranged side by side. A second rib 320 is formed between two adjacent fourth flow channels 310. The plurality of the fourth flow channels 310 are configured to transport the reactant gas along the second direction b. The second direction b is opposite to the first direction a. The shape of the cross-section of each fourth flow channel 310 is rectangular. Along the second direction b, the widths W of the plurality of second ribs 230 are equal to each other, the width W of the cross-section of each fourth flow channel 310 gradually decreases, and the depth H of the cross-section of each fourth flow channel 310 is constant.

The third flow channel unit 200 and the fourth flow channel unit 300 are symmetrically distributed with respect to the center of the bipolar plate 10, which is conducive to improve the utilization rate of the area of the substrate 100 and the volume reduction of the fuel cell.

In an embodiment, the third flow channel unit 200 and the fourth flow channel unit 300 are disposed in the middle portion of the first surface 110. The bipolar plate 10 also includes a first manifold group and a second manifold group. Each of the first manifold group and the second manifold group includes a first reactant gas inflow manifold 610, a first reactant gas outflow manifold 620, a second reactant gas outflow manifold 630, a second reactant gas inflow manifold 640, and a cold water inflow manifold 650. The first manifold group and the second manifold group are disposed on the two opposite sides of the substrate100 and are symmetrically disposed with respect to the center if the bipolar plate 10.

In the first manifold group, the first reactant gas inflow manifold 610, the second reactant gas outflow manifold 630, the cold water inflow manifold 650, the first reactant gas outflow manifold 620, and the second reactant gas inflow manifold 640 are sequentially disposed. The first reactant gas inflow manifold 610 is in fluid communication with the gas inlet of the third flow channel unit 200. The first reactant gas outflow manifold 620 is in fluid communication with the gas outlet of the fourth flow channel unit 300.

In the second manifold group, the second reactant gas inflow manifold 640, the first reactant gas outflow manifold 620, the cold water inflow manifold 650, the second reactant gas outflow manifold 630, and the first reactant gas inflow manifold 610 are sequentially disposed. The first reactant gas inflow manifold 610 is in fluid communication with the gas inlet of the fourth flow channel unit 300. The first reactant gas outflow manifold 620 is in fluid communication with the gas outlet of the third flow channel unit 200.

In the above-described embodiment, the cross-sections of the third flow channel 210 and the fourth flow channel 310 are identical in both shape and size. The shapes of the cross-sections of the third flow channel 210 and the fourth flow channel 310 can be polygonal structures, such as quadrilaterals, hexagons, or octagons.

The cross-sections of the third flow channel 210 and the fourth flow channel 310 can be different in both shape and size.

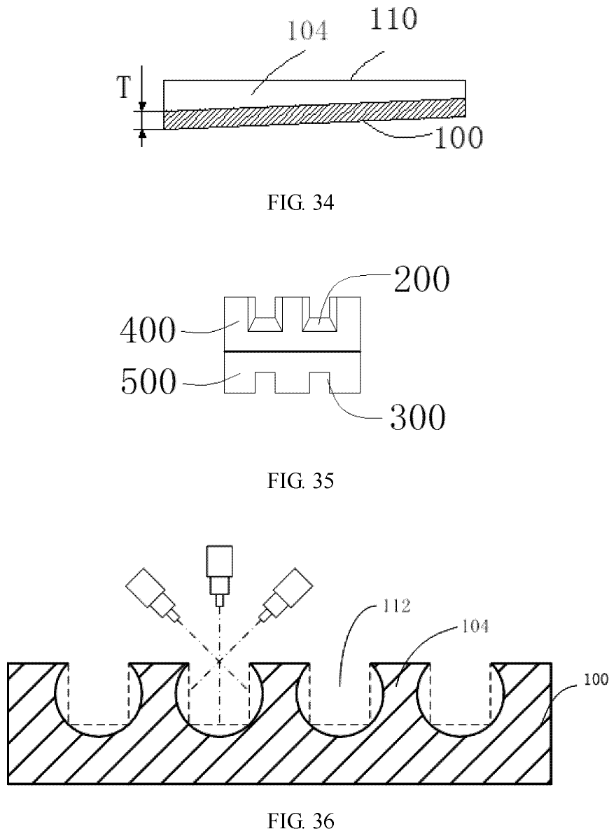

Referring to FIG. 33 and FIG. 34, an embodiment of the present disclosure provides the fuel cell bipolar plate 10. The bipolar plate 10 includes a first substrate 400. The first substrate 400 includes a first surface 110 and a second surface 140 opposite to each other. The first surface 110 defines a third flow channel unit 200. The third flow channel unit 200 includes a plurality of third flow channels 210 arranged side by side. The third flow channels 210 are configured to transport the reactant gas along the first direction a. The shape of the cross-section of each third flow channel 210 is rectangular. Along the first direction a, the shape of the cross-section of each third flow channel 210 remains unchanged, the width W of each third flow channel 210 is constant, the depth of each third flow channel 210 gradually decreases, and the distance T between the bottom surface of the third flow channel 210 and the second surface 140 is constant to ensure the strength of the bipolar plate 10.

In the bipolar plate 10 provided by the embodiment of the present disclosure, the amount of the reactant gas in the third flow channel 210 is constant. Along the first direction a, the shape of the cross-section of the third flow channel 210 remains unchanged, the width W of the third flow channel 210 is constant, and the distance between the bottom surface of the third flow channel 210 and the second surface 140 is constant. The area of the cross-section of the third flow channel 210 gradually decreases, the flow rate of the reactant gas gradually increases, and the flow rate of the water in the third flow channel 210 gradually increases. The bipolar plate 10 makes the water flow rate match the water amount at every position of the third flow channel 210, effectively avoiding the local membrane dryness and the local flooding. The bipolar plate 10 prevents water accumulation in the gas diffusion layer and avoids over drying the proton exchange membrane as well, which reduces the internal polarization loss of the fuel cell and improves the performance of the fuel cell.

In an embodiment, the bipolar plate 10 further includes a second substrate 500. The second substrate 500 includes a third surface 510 and a fourth surface 520 opposite to each other. The fourth surface 520 is attached to the second surface 140. The third surface 510 defines a fourth flow channel unit 300. The fourth flow channel unit 300 includes a plurality of fourth flow channels 310 arranged side by side. The fourth flow channels 310 are configured to transport the reactant gas along the second direction b. The second direction b is opposite to the first direction a. The shape of the cross-section of the fourth flow channel 310 is a rectangle. Along the second direction b, the depth H of the cross-section of the fourth flow channel 310 gradually decreases, the width W of the cross-section of the fourth flow channel 310 is constant, and the distance T between the bottom surface of the fourth flow channel 310 and the fourth surface 520 is constant.

The width W of the cross-section of each third flow channel 210 is constant, and the distance T between the bottom surface of the third flow channel 210 and the second surface 140 is constant. Along the first direction a, the overall thickness of the first substrate 400 decreases. The width W of the cross-section of the fourth flow channel 310 is constant, and the distance T between the bottom surface of the third surface 510 and the fourth surface 120 is constant. Along the second direction b, the overall thickness of the second substrate 500 decreases.

The second substrate 500 and the first substrate 400 are back-to-back arranged, and the reactants in the two substrates flow along opposite directions. The thicker section of the second substrate 500 corresponds to the thinner section of the first substrate 400, and the thinner section of the second substrate 500 is corresponds to the thicker section of the first substrate 400. The overall thickness of the bipolar plate 10 is constant, which can reduce the volume of the fuel cell.

In the above-described embodiment, the cross-sections of the third flow channel 210 and the fourth flow channel 310 are identical in both shape and size. The shapes of the cross-sections of the third flow channel 210 and the fourth flow channel 310 can be polygonal structures, such as quadrilaterals, hexagons, or octagons.

The cross-sections of the third flow channel 210 and the fourth flow channel 310 can be different in both shape and size.

Referring also to FIG. 35, in an embodiment, the depth H of the cross-section of each third flow channel 210 gradually decreases, the width W of the cross-section of each third flow channel 210 gradually decreases, and the distance between the bottom surface of the third flow channel 210 and the second surface 420 is constant. The depth H of the cross-section of the fourth flow channel 310 gradually decreases, the width W of the cross-section of each fourth flow channel 310 is constant, and the distance T between the bottom surface of the fourth flow channel 310 and the fourth surface 520 is constant.

Referring also to FIG. 36, an embodiment of the present disclosure provides a manufacturing method for the fuel cell bipolar plate 10. The method includes: firstly forming the flow channels with the rectangular cross-sections by molding or machining, and then processing the side surfaces of the ribs or the bottom surfaces of the flow channels by using an ultrafast laser. The laser processing is flexible, the power of laser is continuously adjustable, and no mechanical stress is generated during the processing, so that the flow channels with non-rectangular cross-sections or various shaped cross-sections can be processed.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

What is claimed is:

1. A fuel cell bipolar plate, comprising:
a substrate, wherein a surface of the substrate defines a first flow channel and a second flow channel adjacent to the first flow channel, a rib is formed between the first flow channel and the second flow channel, a top surface of the rib defines a groove or a second bore, one or both of the first flow channel and the second flow channel is in fluid communication with the groove or the second bore.

2. The fuel cell bipolar plate of claim 1, wherein the first flow channel and the second flow channel are configured to transport identical reactant gas along a first direction, the groove extends along a second direction, and an angle between the second direction and the first direction is an acute angle.

3. The fuel cell bipolar plate of claim 2, wherein a plurality of grooves are defined on the top surface of the rib; along the first direction, the plurality of grooves are arranged at intervals.

4. The fuel cell bipolar plate of claim 3, wherein along the first direction, a distance between two adjacent grooves gradually decreases.

5. The fuel cell bipolar plate of any one of claim 1, wherein a first bore is defined in the bottom of the groove, and the first bore is in fluid communication with the first flow channel.

6. The fuel cell bipolar plate of claim 5, wherein the first bore comprises a first tunnel and a second tunnel intersected with each other, the first tunnel is in fluid communication with the first flow channel, and the second tunnel is in communication with the second flow channel.

7. The fuel cell bipolar plate of claim 1, wherein the second bore comprises a third tunnel and a fourth tunnel intersected with each other, the third tunnel is in fluid communication with the first flow channel, and the fourth tunnel is in fluid communication with the second flow channel.

8. The fuel cell bipolar plate of claim 7, wherein a plurality of second bores are defined on the top surface of the rib; along the first direction, the plurality of second bores are arranged at intervals.

9. The fuel cell bipolar plate of claim 8, wherein along the first direction, a distance between two adjacent second bores gradually decreases.

10. A fuel cell bipolar plate, comprising:
a substrate, wherein the substrate comprises a first surface, the first surface defines a flow channel, the flow channel is configured to transport reactant gas, an area of a cross-section of the flow channel gradually decreases along a reactant gas transport direction in the flow channel.

11. The fuel cell bipolar plate of claim 10, wherein along the reactant gas transport direction, the area of the cross-section of the flow channel linearly or non-linearly continuously decreases, or gradually, stepwise decreases.

12. The fuel cell bipolar plate of claim 10, wherein a shape of the cross-section of the flow channel is a quadrilateral, a hexagon, an octagon, or a decagon.

13. The fuel cell bipolar plate of claim 10, wherein a side wall of the flow channel is arc-shaped.

14. The fuel cell bipolar plate of claim 10, wherein a shape of the cross-section of the flow channel is a rectangle; along the transport direction, a width of the cross-section of the flow channel gradually decreases, and a depth of the cross-section of the flow channel is constant.

15. The fuel cell bipolar plate of claim 10, wherein a shape of the cross-section of the flow channel is a rectangle; along the transport direction, a depth of the cross-section of the flow channel gradually decreases, and a width of the cross-section of the flow channel is constant.

16. The fuel cell bipolar plate of claim 10, wherein a shape of the cross-section of the flow channel is a rectangle; along the transport direction, a depth of the cross-section of the flow channel gradually decreases, and a width of the cross-section of the flow channel gradually decreases.

17. A fuel cell bipolar plate, comprising:
a first substrate, wherein the first substrate comprises a first surface and a second surface opposite to each other; the first surface defines a third flow channel unit; the third flow channel unit comprises a plurality of third flow channels arranged side by side; the plurality of third flow channels are configured to transport reactant gas along the first direction; a shape of a cross-section of each third flow channel is rectangular.

18. The fuel cell bipolar plate of claim 17, wherein along the first direction, the shape of the cross-section of the each third flow channel remains unchanged, a depth of the each third flow channel gradually decreases, a width of the each third flow channel is constant, and a distance between a bottom surface of the each third flow channel and the second surface is constant.

19. The fuel cell bipolar plate of claim 17, wherein along the first direction, widths of a plurality of first ribs are equal to each other, a width of the cross-section of the each third flow channel gradually decreases, and a depth of the cross-section of the each third flow channel is constant;
the first surface also defines a fourth flow channel unit; the fourth flow channel unit comprises a plurality of fourth flow channels arranged side by side; a second rib is formed between two adjacent fourth flow channels; the plurality of the fourth flow channels are configured to transport reactant gas along a second direction, and the second direction is opposite to the first direction; a shape of a cross-section of each fourth flow channel is rectangular; along the second direction, widths of a plurality of second ribs are equal to each other, a width of the cross-section of theeach fourth flow channel gradually decreases, and a depth of the cross-section of the each fourth flow channel is constant.

20. The fuel cell bipolar plate of claim 17, further comprising:
a second substrate, wherein the second substrate comprises a third surface and a fourth surface opposite to each other; the fourth surface is attached to the second surface; the third surface defines a fourth flow channel unit; the fourth flow channel unit comprises a plurality of fourth flow channels arranged side by side; the plurality of fourth flow channels are configured to transport reactant gas along a second direction, and the second direction is opposite to the first direction; a shape of a cross-section of each fourth flow channel is a rectangle; along the second direction, a depth of the cross-section of the each fourth flow channel gradually decreases, a width of the cross-section of the each fourth flow channel is constant, and a distance between a bottom surface of the each fourth flow channel and the fourth surface is constant.
